(19) United States
(12) Patent Application Publication
(10) Pub. No.: US 2015/0032540 A1
(43) Pub. Date: Jan. 29, 2015

(54) AUTOMATED TARGETING OF INFORMATION INFLUENCED BY DELIVERY TO A USER

(71) Applicant: Staples, Inc., Framingham, MA (US)

(72) Inventors: Ashok Narasimhan, Los Altos Hills, CA (US); Amit Rathore, Burlingame, CA (US)

(21) Appl. No.: 14/479,358

(22) Filed: Sep. 7, 2014

Related U.S. Application Data
(63) Continuation-in-part of application No. 12/843,360, filed on Jul. 26, 2010.
(60) Provisional application No. 61/875,009, filed on Sep. 7, 2013.
(60) Provisional application No. 61/273,056, filed on Jul. 30, 2009.

(51) Int. Cl. G06Q 30/02; G06Q 10/08; G06Q 30/06

(52) U.S. Cl. CPC G06Q 30/0256; G06Q 30/0635; G06Q 10/083
USPC 705/14.53

(57) ABSTRACT

An example system is configured to compile coupled to a computer network behavioral data describing past actions including products viewed and purchases made by users while visiting applications; segment the behavioral data into clusters of behavior factors according to statistically related actions of the users; compile present user data describing a current action of a user while visiting a merchant website hosted by a server coupled to the computer network and accessible by the user on a merchant application; while the user is still visiting the website, compute a match between the present user data and one of the clusters of behavior factors; generate based on the match targeted information influenced by the present user data and the past delivery performance of a merchant and a shipping carrier; and provide the targeted information for presentation while the user is visiting the merchant application.

### CROSS REFERENCE TO RELATED APPLICATIONS

This application is a continuation-in-part of U.S. patent application Ser. No. 12/843,360, entitled “Automated Targeting of Information to a Website Visitor” and filed Jul. 26, 2010, which claims the benefit under 35 U.S.C. §119(e) of U.S. Provisional Patent Application No. 61/273,056, filed Jul. 30, 2009, the entire contents of each of which are incorporated herein by reference. This application also claims the benefit under 35 U.S.C. §119(e) of U.S. Provisional Patent Application No. 61/875,009, entitled “Automated Targeting of Information to a Website User Wherein the Information is Influence by Delivery” and filed Sep. 7, 2013, the entire contents of which are incorporated herein by reference.

### FIELD OF THE DESCRIBED EMBODIMENTS

The described embodiments relate generally to providing information to a potential customer. More particularly, the described embodiments relate, in some cases, to providing automated targeted information to a user while using an application.

### SUMMARY

According to one innovative aspect of the subject matter described in this disclosure, a system includes one or more processors and one or more memories storing instructions that, when executed by the one or more processors, cause the system to: analyze merchant fulfillment data and shipping data to determine a past delivery performance of merchants and shipping carriers; compile coupled to a computer network behavioral data describing past actions including products viewed and purchases made by users while visiting applications hosted by servers accessible by the users via the computer network; segment the behavioral data into clusters of behavior factors according to statistically related actions of the users; compile present user data describing a current action of a user while visiting a merchant website hosted by a server coupled to the computer network and accessible by the user on a merchant application; while the user is still visiting the website, compute a match between the present user data and one of the clusters of behavior factors; generate based on the match targeted information influenced by the present user data and the past delivery performance of a merchant and a shipping carrier; and provide the targeted information for presentation while the user is visiting the merchant application.

In general, another innovative aspect of the subject matter described in this disclosure may be embodied in methods that include analyzing merchant fulfillment data and shipping data to determine a past delivery performance of merchants and shipping carriers; compiling with a server coupled to a computer network behavioral data describing past actions including products viewed and purchases made by users while visiting applications hosted by servers accessible by the users via the computer network; segmenting with the server the behavioral data into clusters of behavior factors according to statistically related actions of the users; compiling with the server present user data describing a current action of a user while visiting a merchant website hosted by a server coupled to the computer network and accessible by the user on a merchant application; while the user is still visiting the website, computing with the server a match between the present user data and one of the clusters of behavior factors; generating with the server based on the match targeted information influenced by the present user data and the past delivery performance of a merchant and a shipping carrier; and providing with the server the targeted information for presentation while the user is visiting the merchant application.

Other implementations of one or more of these aspects include corresponding systems, apparatus, and computer programs, configured to perform the actions of the methods, encoded on computer storage devices.

These and other implementations may each optionally include one or more of the following features such as receiving with the server the merchant fulfillment data describing fulfillment of past orders by the merchants; receiving with the server shipping data for shipping carriers describing deliveries of past orders by the shipping carriers; storing with the server data describing the past delivery performance of the merchants and the shipping carriers in a non-transitory data store; that analyzing the merchant fulfillment data and the shipping data to determine the past delivery performance of merchants and shipping carriers includes determining a timeliness and an accuracy by the merchants and the shipping carriers in respectively fulfilling and delivering the orders; that generating with the server based on the match the targeted information includes generating an estimated time of delivery for delivering one or more products to a physical address associated with the user the past delivery performance of a corresponding merchant and a corresponding shipping carrier; that the past delivery performance of the merchant and the shipping carrier reflects that historically the one or more products are delivered sooner than a standard delivery date range, and the targeted information includes in the estimated time of delivery a prediction that the one or more products would be delivered sooner than the standard delivery date range to convince the user to purchase the one or more products; that generating with the server based on the match the targeted information includes selectively upgrading a method of delivery for delivering one or more products to a physical address associated with the user based on the present user data and including the upgraded method of delivery in the targeted information to convince the user to purchase the one or more products; allotting an amount of money to a virtual money pool by storing data representing the money in a non-transitory data store, wherein selectively upgrading the method of delivery is based on an availability of a required sum of money within a money pool to cover the upgrade; that the money pool is associated with the merchant of the one or more products and the money pool is funded by the merchant; and that the money pool is funded by a community of one or more users in association with previously purchased products.

It should be understood that the language used in the present disclosure has been principally selected for readability and instructional purposes, and not to limit the scope of the subject matter disclosed herein.

### BACKGROUND

Online shopping is continually increasing in popularity and has evolved with the growth in technology. Many consumers visit online shopping websites to compare product features and their prices. However, the percentage of online consumers who actually buy a product after viewing it online is very low. An online consumer is mainly influenced by the sales price offered for a particular product. In cases where the sales price offered is appropriate, the online consumer will end up buying the product online.

In order to efficiently use the consumer behavior data, a number of price optimization techniques have been developed. The techniques consider various consumer behavior factors such as time spent on a website, type of products browsed, etc., to provide a consumer with an incentivized pricing scheme. However, most of the price optimization techniques suffer from one or more limitations.

One limitation of existing price optimization techniques is the low conversion ratio of consumers visiting the website to consumers making an online purchase through the website. Further, another limitation of the existing price optimization techniques is to monitor consumer behavior on a large scale across a large number of websites and merchant types. Monitoring consumer behavior on a large scale requires deployment of an extensive hardware and software infrastructure.

There is a need for a method, and a system for optimizing information provided to different consumers based on the stage of the product purchase cycle a consumer is in. Further, there exists a need for providing an optimum pricing mechanism for a merchant that is based on present consumer behavior and predetermined past customer behavior

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 shows an example of system for collecting and analyzing behavioral data of a plurality of users from a plurality of applications (e.g., websites).

FIG. 2 shows an example of system for matching the present user data with at least one of the different clusters of behavior factors, and while the present user is still visiting the present application (e.g., website), generating and displaying targeted information to the present user.

FIG. 3 is a flow chart that includes an example method of targeting information to a user while using an application.

FIG. 4 is a flow chart that includes steps of a method of providing real-time targeted information to a consumer.

FIG. 5 is a flow chart that includes an example method of providing real-time targeted economic value information to a consumer.

FIG. 6 shows a computing architecture in which the described embodiments can be implemented.

### DETAILED DESCRIPTION

The embodiments described include methods and apparatuses for providing automated, real-time information targeted to a website visitor. In some embodiments, this includes providing price discounts in real time based on consumer characteristics to increase the conversion ratio of online consumers visiting a merchant's application to online consumers making a purchase on the application.

Typically, online consumers leave a merchant's application after viewing the product details page. Some consumers may add a product to their shopping cart, but later discontinue the purchase of the product in the shopping cart. However, a consumer who has added a product to the shopping cart is more likely to purchase the product than the consumer who has simply viewed the product details page. Such consumer behavioral data of those who added a product to their shopping cart, if collected, can be used for various purposes such as setting the sale price or offering discounts on the sale price of a product.

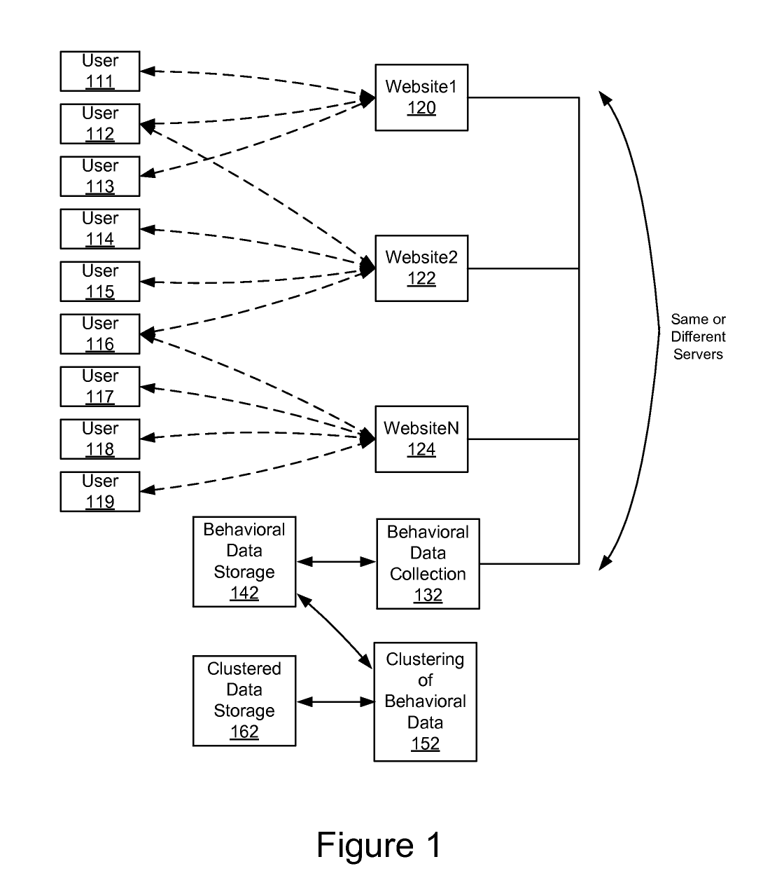

FIG. 1 shows an example of system for collecting and analyzing behavioral data of users from a plurality of applications, such as websites, although other variations are possible where an application's acts, structure, and/or functionality is distributed between an application operating natively on a user's computer and an application hosted by a server coupled to a computer network. As shown, exemplary users 111-119 visit websites 120, 122, 124. The actions of the users 111-119 as they visit the websites 120, 122, 124 can be monitored and collected. More specifically, behavioral data of the users 111-119 can be collected from the websites 120, 122, 124 by monitoring the websites 120, 122, 124 and collecting the data about the users. The users 111-119 include computing devices coupled to a computer network, to which the websites 120, 122, and 124 and server 132 and 152 are also coupled. The network may include any computer network across which computing devices may communicate and interact, such as public and private networks, virtual networks, etc.

As shown, a server 132 collects the behavior data which is then stored (storage 142).

The storage 142 or storage 162 may be a non-transitory storage device that stores data. For example, the storage 142 or storage 162 may include a dynamic random access memory (DRAM) device, a static random access memory (SRAM) device, flash memory, and/or some other memory device. In some implementations, the storage 142 or storage 162 includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, and/or some other non-volatile storage device.

In some embodiments, the collected data may include actions of the visiting users before arriving at the merchant application, actions taken on the merchant application such as which pages were viewed in what order, products placed into a shopping cart, purchases subsequently made by the visiting users, etc. For instance, the collected behavior data includes past actions including products viewed and purchases made by users while using applications. The collected data can include, for example, pre-click information, checkout status, and/or post-click information. A non-exhaustive exemplary list of pre-click information includes a referral URL (Universal Resource Locator), search (such as, search, number of search terms, specific search terms, specific search phrases), banner advertisements (such as, advertisement context, referrer domain, second referrer domain), comparison engine (such as, number of search terms, specific search terms, specific search phrases, comparison page context, customer entered zip code), referrer domain, referrer page contents (such as, shopping comparison site), customer information (such as, return customer, characterizing history data), customer location (such as, time zone, location, demographics, weather, merchant shipping costs). A non-exhaustive exemplary list of check out status includes adding to cart, viewing cart and/or checkout. A non-exhaustive exemplary list of post-click information includes path/actions through site, products viewed, browsing pattern, time on site, cart contents (such as, products, product groups, value, abandonment), current location in funnel, day of week, special day and/or price modifications already applied.

In some embodiments, the collected data may include present user data, which is data collected in real-time (e.g., contemporaneously with a user's use of an application, such as a website, etc.) describing a current action of a user while using a merchant application, the current action includes the user adding a product to a virtual shopping cart of the merchant application. For instance, the present user data may include one or more user actions reflecting a user's behavior in interacting with the application.

A server 152 analyzes the collected behavior data. The analyzing can include clustering the collected behavioral data, which in some embodiments, includes segmenting the collected behavioral data into clusters of behavior factors according to statistically related actions of the users. The segmented behavior factors can be used to predict future behavior of the users. The clustered collected behavioral data can be stored in clustered data storage 162 for future access.

For example, the collected behavioral data may indicate, through statistical analysis, that visiting users who view certain pages of a website, such as those describing a tennis racket, are more likely to purchase certain products (such as tennis balls) if offered at a certain discount, than those who do not view those pages.

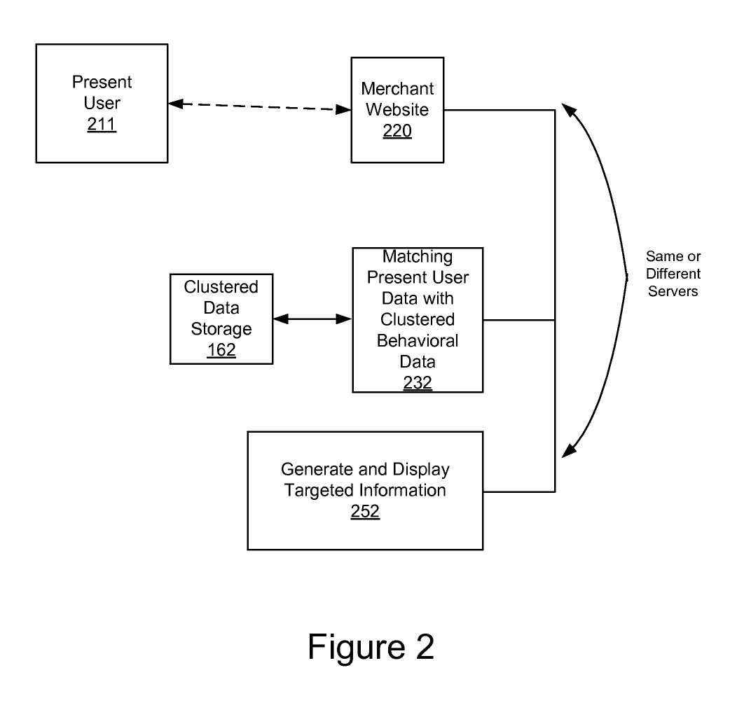

FIG. 2 shows an example system for matching the present user data with at least one of the clusters of behavior factors, and while the present user is still visiting the present application (e.g., website), generating and displaying targeted information to the present user. A present user 211 accesses a merchant website 220. A server 232 executes a matching of the present user data with at least one of the clusters of behavior factors.

It should be understood that the servers 132, 152, 232, and 252, and the servers hosting the websites 120, 122, 124, and 220, as shown and described, may be the same server, the same group of servers, common/shared servers, distinct servers (coupled via a network for communication), a combination of the foregoing, etc. Moreover, the use of the term server is not limited to a single virtual, software, and/or hardware server but may include two or more such servers depending on the embodiment.

In some embodiments, the matching is based on a comparative analysis of the present user data with the clustered behavior factors of the clustered database stored in the storage 162. In some embodiments, the comparative analysis includes identifying correlations between the present user data and each of the clustered behavior factors, and identifying which of the clustered behavior factor is most correlated to the present user data, thereby identifying a match between the present user data and the at least one cluster of behavior factors. In a non-limiting example, a match includes using one of the clusters of behavior factors from the collected behavioral data of the users that have used the merchant application previously and using one of the clusters of behavior factors for finding a corresponding relationship to the present user data of the user while using the merchant application. For example, the behavioral data collected from the users may include content reviewed by the users across many applications. The content reviewed may include but is not limited to, a car blog on the merchant application and/or search terms such as (Ford, V8 engine, tires, etc.) entered by the users. In some embodiments, the collected behavioral data is segmented by the server 152 into clusters of behavior factors that contain similar behaviors (pages browsed, search terms, etc.) of the users. In some embodiments, the present user data may include similar pages browsed, search terms entered (American cars, V8 engine, summer tires, etc.) and blogs visited on the merchant application. Using the present user data and one of the clusters of behavior factors the server 232 computes the match by comparing the present user data with one of the clusters of behavior factors collected and upon a successful correlation, the server 252 will provide targeted information (ads, recommended products, etc.) to the present user. Numerous other variations are also possible and contemplated.

Some embodiments include the present user loading pages from the application that describe tennis rackets. Contemporaneous to the load, the server 232 collects data describing the pages being loaded on the application and matches one or more characteristics of the pages (products included in the pages), to one or more clusters of behavior factors in the clustered behavioral data of server 232 and clustered database stored in the storage 162. In some embodiments, the stored clustered behavioral data may include clusters that describe the present user as a certain shopper such as one that purchases products associated with a specific category (e.g. gardening, sports, home appliances, furniture) and/or purchases products (e.g., tennis balls) that are discounted.

In some embodiments, for example, the match may include identifying with the server 232 a corresponding relationship between the products browsed by the user on the pages and one of the clusters of behavior factors associated with the user, which in return may include identifying the present user as likely to purchase the product (e.g., tennis balls) if offered at a certain discount. The process of matching data occurs in an elapsed time short enough such that actions subsequently motivated by the match can be made without the present user being aware that such time has elapsed and before the present user can perform another action, such as leaving the application (e.g., merchant website).

Existing methods of matching user data to behavioral segments cannot effect the match in a manner timely enough not to be noticed by users or to allow the system to take actions to affect user behavior before the user takes actions that preclude it, such as leaving the application.

A server 252 provides targeted information (e.g., a price discount for an in-cart product) based upon the matching.

For example, the completed match for present users who view pages describing tennis rackets may indicate that these users should be offered a discount on tennis balls, and further, that such discount should be of a particular size (amount) to optimize the overall profit gained by the merchant.

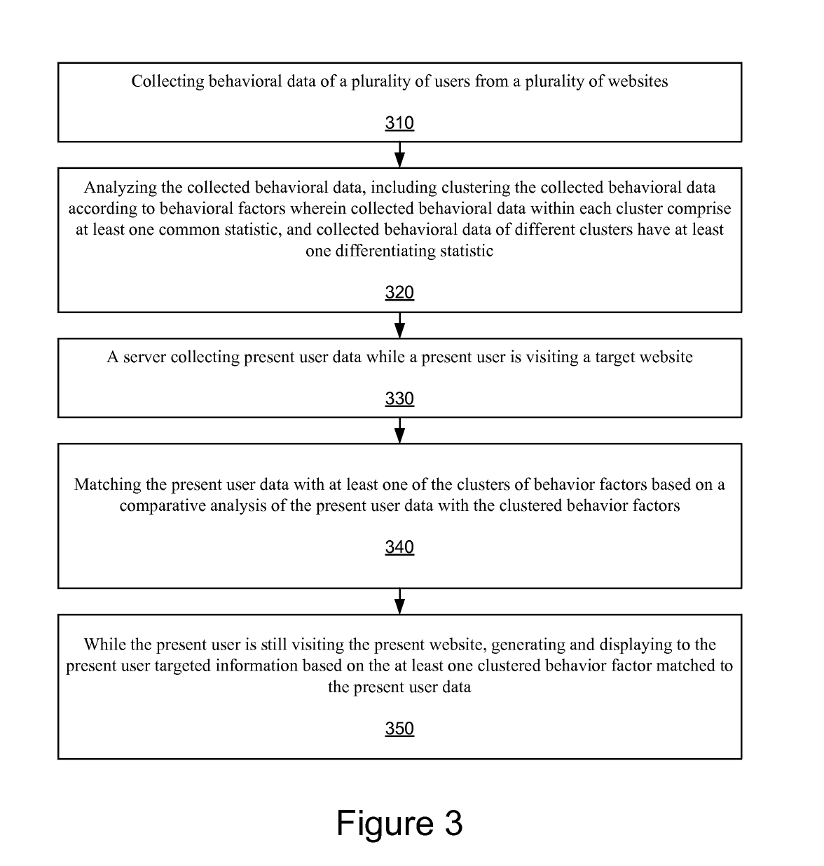

FIG. 3 is a flow chart that includes steps of an example method of targeting information to a user while using an application. A first step 310 includes collecting behavioral data of users from a plurality of applications. A second step 320 includes analyzing the collected behavioral data, including clustering the collected behavioral data according to behavioral factors. The collected behavioral data within each cluster may include at least one common statistic, and collected behavioral data of different clusters have at least one differentiating statistic. A non-limiting example of a common statistic within each cluster may include products of the same manufacture and a category browsed by users while using the application, while a differentiating statistic within each cluster may include products of the same category (tires, etc.) but different manufactures (Michelin, Bridgestone, Toyo, etc.). A third step 330 includes a server 232 collecting present user data while a present user is visiting a target application (e.g., website, native app, etc.). A fourth step 340 includes the server 232 matching the present user data with at least one of the clusters of behavior factors based on a comparative analysis of the present user data with the clustered behavior factors. A fifth step 350 includes while the present user is still visiting the present application, generating and displaying to the present user targeted information (via the server 252 and/or the computer of the present user) based on the at least one clustered behavior factor matched to the present user data.

### Shipping and Delivery

Some embodiments further include analyzing past delivery performance of the merchant and the shipping carrier. Some embodiments further include providing the user with an estimate of time of delivery based on the analyzed past delivery performance of the merchant and the shipping carrier. This is particularly useful in cases where the merchant uses the cheapest carrier/service to ship items to the user, and the delivery estimates are broad (7 to 21 business days). With this, the estimates can be tightened based on the predictions of what is expected from statistical past performance. In some embodiments, the estimate of time of delivery is provided to the user through the targeted information. This is useful when, for example, a free ground-shipping offer that is typically promised to arrive in 7-21 business days, can be promised to arrive in 2 days, translating to the value derived from making a free 2-day shipping offer.

As a further example, in an example method, the server 152 may be configured, via software storable in one or more memories of the server 152 and executable by one or more processors, to analyze merchant fulfillment data and shipping data to determine a past delivery performance of merchants and shipping carriers. In some implementations, the server 152 determine this past delivery performance analysis by determining a timeliness and an accuracy by the merchants and the shipping carriers in respectively fulfilling and delivering the orders. In some implementations, the server 152 may be configured to store data describing the past delivery performance of the merchants and the shipping carriers in a non-transitory data store for later access and/or analysis.

To determine the merchant fulfillment data and the shipping data, in some embodiments, the server 152 may be configured to receive the merchant fulfillment data describing fulfillment of past orders by the merchants and receive shipping data for shipping carriers describing deliveries of past orders by the shipping carriers from one or more data sources, such as an internal or external database, servers associated with the merchants and/or shipping carriers, etc. The server 152 may include or be coupled to a non-transitory data store to store, retrieve, and/or otherwise manipulate the merchant fulfillment data and the shipping data.

The server 132 may be configured to then compile behavioral data describing past actions including products viewed and purchases made by users while visiting applications hosted by servers accessible by the users via the computer network. The server 152 may segment the behavioral data into clusters of behavior factors according to statistically related actions of the users. The server 232 may compile present user data describing a current action of a user while using a merchant application hosted by a server coupled to the computer network and accessible by the user on a merchant application. The server 232 may compute a match between the present user data and one of the clusters of behavior factors. For instance, the present user data may reflect that the user is interested in purchasing one or more products via a merchant's application (e.g., website) (e.g., by adding one or more products to a virtual shopping cart).

The server 252 may then generate based on the match targeted information influenced by the present user data and the past delivery performance of a merchant and a shipping carrier and provide the targeted information for presentation while the user is visiting the merchant application. In some embodiments, generating with the server 252 based on the match the targeted information includes generating an estimated time of delivery for delivering one or more products to a physical address associated with the user the past delivery performance of a corresponding merchant and a corresponding shipping carrier, although other variations are also possible and contemplated.

Some embodiments further include selectively upgrading the delivery to the user based on the user, the merchant, and the shipping carrier. For instance, the past delivery performance of the merchant and the shipping carrier may reflect that historically the one or more products are delivered sooner than a standard delivery date range, and the targeted information includes in the estimated time of delivery a prediction that the one or more products would be delivered sooner than the standard delivery date range to convince the user to purchase the one or more products. This is useful when by spending, say 2-3%, of the cart value to upgrade the shipment service to a faster one (say 2 day or 3 day) can tip the shopper into becoming a buyer.

In some embodiments, selectively upgrading is based on availability of money within a money pool. In some embodiments, an amount of money is allotted by the server 232 to a virtual money pool by storing data representing the money in a non-transitory data store and the server 252 selectively upgrades the method of delivery based on an availability of a required sum of money within a money pool to cover the upgrade. For instance, the money may be used to do the selective delivery carrier/service upgrades come from a pre-defined maximum pool.

In some instances, the money pool is associated with the merchant of the one or more products and the money pool is funded by the merchant, is funded by a community of one or more users in association with previously purchased products, or by other suitable means. For instance, the money pool is provided by the merchant and is used to do the selective delivery carrier/service upgrades. In other words, the money may come from a pre-defined maximum pool, provided by the merchant itself. In another example, the money pool is provided by one or more users and used to do the selective delivery carrier/service upgrades. For instance, the money may come from a pre-defined maximum pool, and is provided by collecting, say $1 to $3 from each shopper who opts for upgraded shipping.

In some instances, the targeted information may be determined while the user is still visiting the website, although other variations are possible such as determining the targeted information afterwards and then notifying the user (e.g., via electronic message, push notification, an embedded advertisement, etc.) of the targeted information to redirect the user to complete a purchase based on the targeted information.

In some embodiments, clustering the collected behavioral data includes segmenting the collected behavioral data into behavior factors according to statistically related actions of the users, where the segmented behavior factors can be used to predict future behavior of the users.

In some embodiments, compiling behavioral data of a user while using a merchant application includes, monitoring the merchant application and compiling present user data describing a current action of the user while using the merchant application. For example, the current action includes the user adding a product to a virtual shopping cart of the merchant application.

In some embodiments, while the user is still using the merchant application, incudes performing a comparative analysis including determining a match between the present user data and a cluster from the clusters of behavior factors and generating a demand function based on the match and the business rules associated with the merchant application.

In some embodiments, the comparative analysis includes determining a match between the present user data and a cluster from the clusters of behavior factors and generating a demand function based on the match and the business rules associated with the merchant application.

For example, in some embodiments, the comparative analysis of the present user data with the clustered behavior factors includes identifying correlations between the present user data and each of the clustered behavior factors, and identifying which of the clustered behavior factor is most correlated to the present user data, thereby identifying a match between the present user data and the at least one cluster of behavior factors. The identified correlation can include, for example, at least one of timing of user actions, and history of the user. The timing of user actions can include, for example, at least one of timing of elapsed time between the user's appearance on the present application and first carting, or timing between visits by the user to the present application. The history of the user can include at least one of information of whether the user was directed to the present application through a search service, whether the user was directed to the present application through a comparison shopping service, the user's order of pages browsed, search terms used by the user to arrive at the present application, attributes of a referring application.

In some embodiments, the identified correlations include at least one of a computer type (for example, Macintosh® versus PC) of the user, an operating system type (such as, Windows® versus Unix) of the user, a browser type of the user (for example, Explorer® versus Netscape), or a location (for example, latitude and longitude) of the user.

In some embodiments, the match is between the present user data and a precompiled cluster of behavior factors. In some embodiments, generating targeted information based on the comparative analysis includes a discount for the product in the virtual shopping cart. In some embodiments, the targeted information including the discount for the product in the virtual shopping cart is provided to the user before the user leaves the merchant application. This particular point in the user's application visit can be a particularly opportune time to offer, for example, the discount that will prompt a transaction to actually occur.

In some embodiments, the targeted information is additionally based on product information of competitive merchant products. The product information can be obtained, for example, by determining past search terms used by the present user, running a real-time search during the present user's session, determining competitive merchants based on search results of the real-time search. By analyzing the prices offered by the competitors, a comparative analysis of the prices offered by all the players, including the competitors and the merchant can be performed. Typically, a consumer is directed to a merchant's webpage through a search engine. The search terms are included in the referral URL, which has directed the consumer to the merchant's webpage. Search terms used by the consumer can be identified based on the URL parameters in the merchant's webpage passed on by the search engine. Those search terms can be entered at the search application to download the search results page, and store the results for an offline analysis.

During an offline analysis, pricing of similar products offered by competitors, which have been provided by the search engine, are identified. Competitor data can be aggregated in search results such as the price data of the competitor products, or merchant data listed in the search results page. The competitor data is related with the consumer's behavior on the merchant's application. A “quality score” for the search results page produced can be calculated from search terms. The quality score is determined by ascertaining a Click Through Rate (CTR) of a user on the merchant's application among the search results. CTR is obtained by dividing the number of users who clicked on a link by the number of times the link was delivered. A server can then provide feedback to the merchant on the performance of activities in search engine optimization and Search Engine Marketing (SEM) such as buying keywords from SEM vendors such as Google® AdWords, Yahoo!® Search Marketing and Microsoft® adCenter. Search engine optimization is a process of enhancing the volume of web-traffic from a search engine to a merchant's site. Competitors' product prices can be compared to the merchant's product prices. This analytic data can be provided to the merchant for price optimization.

Some embodiments include collecting (obtaining) additional information of a customer by using a JavaScript program on the merchant application. The JavaScript program in real time identifies the consumer based on the cookies in the consumer's browser, and the program stores a real-time feed of the consumer's behavior.

First-party cookies can be dropped by the merchant's website onto the consumer's browser, which may be used for tracking the consumer across all of the merchants serviced by the automated price optimization service. When a consumer visits a merchant's application, the JavaScript program opens a first IFrame within the merchant's webpage. The first IFrame corresponds to a web page hosted on a server. The first IFrame searches for a first-party cookie belonging to the server and including identification information of a consumer. If the consumer is new and no earlier first-party cookie is identified, a new first-party cookie is dropped on the consumer's browser. The first IFrame then launches a second hidden IFrame hosted on the merchant's server. The consumer identification information is passed on to the second IFrame as parameters within the Uniform Resource Locator (URL) of the second hidden IFrame. The second hidden IFrame then stores the consumer identification information in a new or existing first-party cookie corresponding to the merchant's application. Thereafter, the consumer identification information is passed from a cookie corresponding to a cookie corresponding to any other merchants' application. Therefore, the consumer is tracked on any merchant's application, even if the consumer has disabled or blocked third-party cookies on his/her browser.

The JavaScript program also gathers consumer behavioral information, such as shopping data before purchase and after purchase, prices offered, and purchase history, and stores it in database for an offline analysis. Consumers are identified by using cookies on their browsers. The JavaScript program runs on the web pages of all the merchants. This helps in gathering consumer behavioral information from multiple merchants' applications.

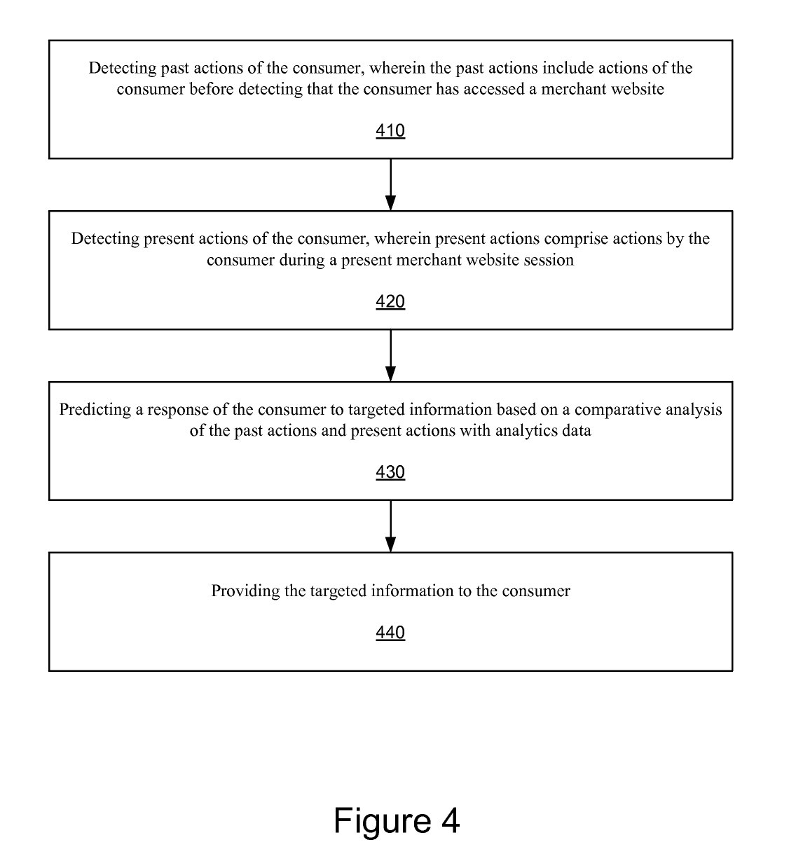

FIG. 4 is a flow chart that includes steps of a method of providing real-time targeted information to a consumer. A first step 410 includes detecting past actions of the consumer, where the past actions include actions of the consumer before detecting that the consumer has accessed a merchant application. A second step 420 includes detecting present actions of the consumer, where present actions include actions by the consumer during a present merchant application session. A third step 430 includes predicting a response of the consumer to targeted information based on a comparative analysis of the past actions and present actions with analytics data. A fourth step 440 includes providing the targeted information to the consumer.

In some embodiments, the analytic data is collected and analyzed. For example, as previously described, this can include collecting behavioral data of a plurality of users from a plurality of applications. The collected behavioral data is analyzed by clustering the collected behavioral data according to behavioral factors where collected behavioral data within each cluster comprise at least one common statistic, and collected behavioral data of different clusters have at least one differentiating statistic.

As previously mentioned, the providing of the targeted information to the consumer can be conditioned upon a determination that the consumer is attempting to leave the merchant application. In some embodiments, providing the targeted information to the consumer includes embedding and integrating the targeted information into the merchant's application.

As previously described, detecting past actions of the consumer can include determining past search terms used by the consumer, running a real-time search during the consumers present session, and determining competitive merchants based on search results of the real-time search. This can further include analyzing product information of the competitive merchants, and generating targeted information based on the analyzed product information.

In some embodiments, the comparative analysis includes generating a demand function for the consumer, where the demand function includes consumer characteristics, predetermined merchant rules, competitive information, and/or product type. Prices presented on the merchant's application can be managed based on the demand function. The demand function can be adaptively updated.

For example, a present user that views pages describing tennis rackets may be willing to purchase tennis balls at a price different from other users who had not viewed such pages. The demand function describes such willingness to buy products, at various prices, depending on the segment or factor a given user was matched to in the Consumer Behavioral Data.

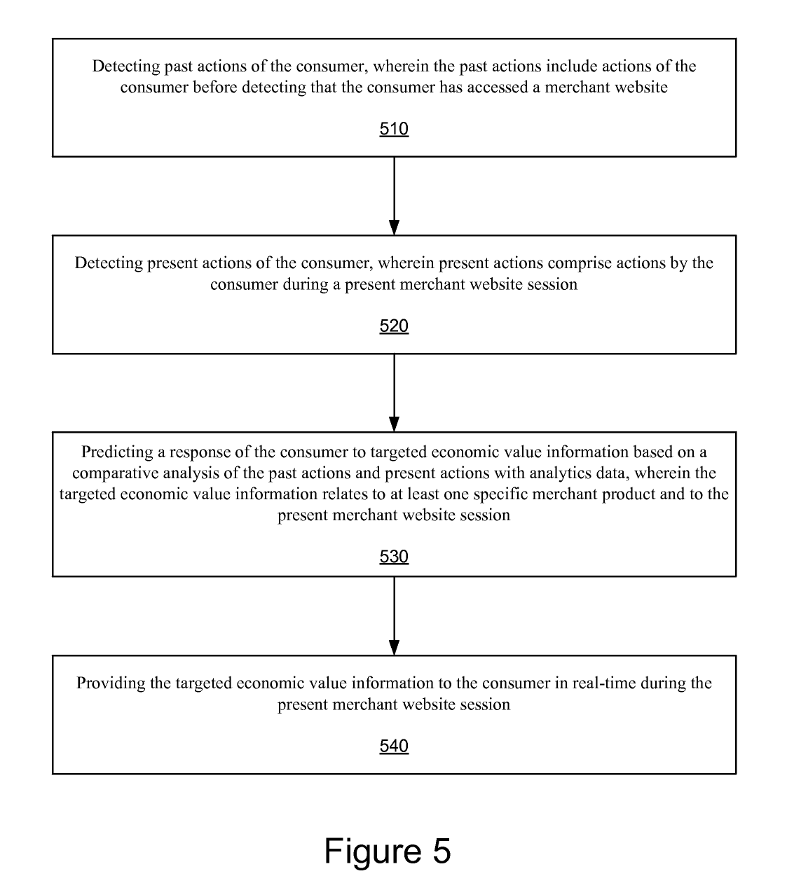

FIG. 5 is a flow chart that includes the steps of an example of a method of providing real-time targeted economic value information to a consumer. A first step 510 includes detecting past actions of the consumer, where the past actions include actions of the consumer before detecting that the consumer has accessed a merchant application. A second step 520 includes detecting present actions of the consumer, where present actions comprise actions by the consumer during a present merchant application session. A third step 530 includes predicting a response of the consumer to targeted economic value information based on a comparative analysis of the past actions and present actions with analytics data, where the targeted economic value information relates to at least one specific merchant product and to the present merchant application session. A fourth step 540 includes providing the targeted economic value information to the consumer in real-time during the present merchant application session.

In some embodiments, the targeted economic value information includes a specific offer of a price for a specific product. However, in some embodiments, the targeted economic value information includes things other than price. For example, an offer of free shipping or a two-for-one offer can additionally or alternatively be provided as examples of targeted economic value information. The targeted economic value information can be provided to the consumer in real-time during the present merchant application session. That is, the information is generated and displayed fast enough that the consumer visiting the merchant's application perceives the displayed information as “real-time.” That is, the consumer cannot observe a noticeable delay. The information is provided while the consumer is still on the merchant's application, and can be triggered, for example, by the consumer exiting a merchant application shopping cart, or attempting to leave the merchant's application without a purchase being completed.

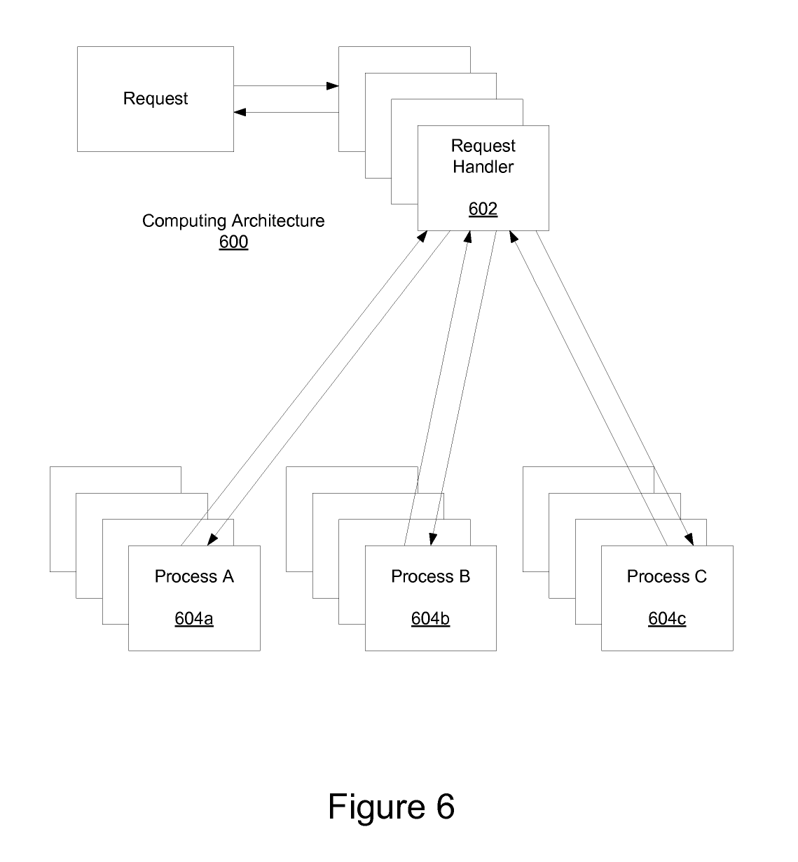

FIG. 6 shows a computing architecture in which the described embodiments can be implemented. In some embodiments, the prediction of the response of the consumer to targeted information is computed on a scalable computing architecture. In some embodiments, the scalable computing architecture includes swarm processing. The computer architecture of FIG. 6 can be particularly useful because it is a highly-scalable, parallel-processing architecture. The computing architecture 600 can be used for implementing the various functions previously described, such as behavioral data collection 132, behavioral data storage 142, clustering of behavioral data 152, clustered data storage 162, matching present user data with clustered behavioral data 232, and/or generating and targeting information 252.

In these embodiments, the computing architecture 600 comprises a request handler 602 and a multiple-processing framework and multiple concurrent processes 604 (604a, 604b, 604c), each such process representing a sub-task of a larger task that the architecture has been directed to complete. The computing architecture 600 can be implemented by a network of computers, such that the request handler 602 can assign any one or a multitude of the concurrent processes to any one or a multitude of networked computers (networked computers that can be communicated with by the computing architecture over available computer networks) for the completion of the task. Therefore, the overall capacity of the computing architecture to complete a task or a multitude of tasks within a certain elapsed time is only limited by the number of networked computers available. As the number of tasks grows, such as may occur by the addition of applications or visiting users, or the requirement for elapsed time to process a task decreases, or both, the computing architecture can successfully meet such requirements by adding additional networked computers, without limit.

For example, some embodiments include the simultaneous matching being handled by a request handler. The request handler receives multiple requests for matching and assigns any one or a multitude of the requests for matching to any one or a multitude of networked computers (networked computers that can be communicated with by the computing architecture over available computer networks) for the completion of the requests for matching. In some embodiments, clustering the collected behavioral data according to behavioral factors is handled by a request handler. The request handler receives multiple requests for clustering and assigns any one of a multitude of the requests for clustering to any one or a multitude of networked computers for the completion of the requests for clustering.

As a present user loads pages from the application that describe, for example, tennis rackets, contemporaneous to the load, a first server 132 executes the behavioral data collection of data describing the pages being loaded, while a second server 232 executes matching of present user data to one or more segments of clustered behavioral data. Some embodiments include the first and second servers employing the computing architecture 600 by accepting the task of matching the incoming data of the present user to segments in the Clustered Behavioral Data. In some embodiments, the task of matching is broken down into smaller sub-tasks that are assigned by the request handler 602 to various processes 604 (a, b, c). The request handler 602 subsequently assigns one or more processes 604 (a, b, c) to one or more networked computers. The assignment can be made for optimal speed of completion of each process 604. When all the processes 604 (a, b, c) are complete, the request handler 602 assembles the results of each sub-task from each corresponding processes 604 (a, b, c) into a complete result of the original task, namely that users who view tennis rackets are likely to buy tennis balls when offered a discount of a certain size.

In some embodiments, the request handler 602 includes Swarmiji, and the processes 604a, 604b, 604c include Sevaks. Only three Swarmiji Sevaks 604a, 604b, and 604c are shown for the purpose of illustration. Swarmiji Sevak is a Swarmiji worker process, and it can be easily spawned and coordinated to process real time or static data with a high degree of parallelism. Request handler 602 receives a request for a report or data from a requestor, such as a browser, a pricing engine, or a merchant. Thereafter, request handler 602 dispatches partial requests to Swarmiji Sevaks 604a, 604b, and 604c. Swarmiji Sevaks 604 a, 604b, and 604c complete partial requests and return the report to request handler 602. Request handler 602 then uses these reports to build a consolidated report and sends the report back to the requestor.

Swarmiji is a framework for creating and harnessing swarms of scalable concurrent processes called Swarmiji Sevaks. The framework is primarily written in Clojure on the Java Virtual Machine (JVM), which can utilize libraries from any JVM-compatible language.

The framework draws heavily from existing systems such as Erlang, Termite, and the latest Nanite. The framework uses isolated processes to distribute computational load and pass messages to facilitate communication between processes. The framework also includes a management system that handles resource monitoring, process monitoring, etc.

Although specific embodiments have been described and illustrated, the embodiments are not to be limited to the specific forms or arrangements of parts so described and illustrated.

What is claimed is:

1. A computer-implemented method comprising:
analyzing merchant fulfillment data and shipping data to determine a past delivery performance of merchants and shipping carriers;
compiling with a server coupled to a computer network behavioral data describing past actions including products viewed and purchases made by users while visiting applications hosted by servers accessible by the users via the computer network;
segmenting with the server the behavioral data into clusters of behavior factors according to statistically related actions of the users;
compiling with the server present user data describing a current action of a user while visiting a merchant website hosted by a server coupled to the computer network and accessible by the user on a merchant application;
while the user is still visiting the website, computing with the server a match between the present user data and one of the clusters of behavior factors;
generating with the server based on the match targeted information influenced by the present user data and the past delivery performance of a merchant and a shipping carrier; and
providing with the server the targeted information for presentation while the user is visiting the merchant application.

2. The method of claim 1, further comprising:
receiving with the server the merchant fulfillment data describing fulfilment of past orders by the merchants;
receiving with the server shipping data for shipping carriers describing deliveries of past orders by the shipping carriers; and
storing with the server data describing the past delivery performance of the merchants and the shipping carriers in a non-transitory data store, wherein analyzing the merchant fulfillment data and the shipping data to determine the past delivery performance of merchants and shipping carriers includes determining a timeliness and an accuracy by the merchants and the shipping carriers in respectively fulfilling and delivering the orders.

3. The method of claim 1, wherein generating with the server based on the match the targeted information includes generating an estimated time of delivery for delivering one or more products to a physical address associated with the user the past delivery performance of a corresponding merchant and a corresponding shipping carrier.

4. The method of claim 3, wherein the past delivery performance of the merchant and the shipping carrier reflects that historically the one or more products are delivered sooner than a standard delivery date range, and the targeted information includes in the estimated time of delivery a prediction that the one or more products would be delivered sooner than the standard delivery date range to convince the user to purchase the one or more products.

5. The method of claim 1, wherein generating with the server based on the match the targeted information includes selectively upgrading a method of delivery for delivering one or more products to a physical address associated with the user based on the present user data and including the upgraded method of delivery in the targeted information to convince the user to purchase the one or more products.

6. The method of claim 5, further comprising:
allotting an amount of money to a virtual money pool by storing data representing the money in a non-transitory data store, wherein selectively upgrading the method of delivery is based on an availability of a required sum of money within a money pool to cover the upgrade.

7. The method of claim 6, wherein the money pool is associated with the merchant of the one or more products and the money pool is funded by the merchant.

8. The method of claim 6, wherein the money pool is funded by a community of one or more users in association with previously purchased products.

9. A system comprising:
one or more processors; and
one or more memories storing instructions that, when executed by the one or more processors, cause the system to:
analyze merchant fulfillment data and shipping data to determine a past delivery performance of merchants and shipping carriers;
compile coupled to a computer network behavioral data describing past actions including products viewed and purchases made by users while visiting applications hosted by servers accessible by the users via the computer network;
segment the behavioral data into clusters of behavior factors according to statistically related actions of the users;
compile present user data describing a current action of a user while visiting a merchant website hosted by a server coupled to the computer network and accessible by the user on a merchant application;
while the user is still visiting the website, compute a match between the present user data and one of the clusters of behavior factors;
generate based on the match targeted information influenced by the present user data and the past delivery performance of a merchant and a shipping carrier; and
provide the targeted information for presentation while the user is visiting the merchant application.

10. The system of claim 10, where the instructions, when executed by the one or more processors, further cause the system to:
receive the merchant fulfillment data describing fulfilment of past orders by the merchants;
receive shipping data for shipping carriers describing deliveries of past orders by the shipping carriers; and
store data describing the past delivery performance of the merchants and the shipping carriers in a non-transitory data store, wherein analyzing the merchant fulfillment data and the shipping data to determine the past delivery performance of merchants and shipping carriers includes determining a timeliness and an accuracy by the merchants and the shipping carriers in respectively fulfilling and delivering the orders.

11. The system of claim 10, wherein generating with the server based on the match the targeted information includes generating an estimated time of delivery for delivering one or more products to a physical address associated with the user the past delivery performance of a corresponding merchant and a corresponding shipping carrier.

12. The system of claim 11, wherein the past delivery performance of the merchant and the shipping carrier reflects that historically the one or more products are delivered sooner than a standard delivery date range, and the targeted information includes in the estimated time of delivery a prediction that the one or more products would be delivered sooner than the standard delivery date range to convince the user to purchase the one or more products.

13. The system of claim 10, wherein generating with the server based on the match the targeted information includes selectively upgrading a method of delivery for delivering one or more products to a physical address associated with the user based on the present user data and including the upgraded method of delivery in the targeted information to convince the user to purchase the one or more products.

14. The system of claim 13, further comprising:
allotting an amount of money to a virtual money pool by storing data representing the money in a non-transitory data store, wherein selectively upgrading the method of delivery is based on an availability of a required sum of money within a money pool to cover the upgrade.

15. The system of claim 14, wherein the money pool is associated with the merchant of the one or more products and the money pool is funded by the merchant.

16. The system of claim 14, wherein the money pool is funded by a community of one or more users in association with previously purchased products.
